(19) United States
(12) Patent Application Publication
(10) Pub. No.: US 2008/0119160 A1
(43) Pub. Date: May 22, 2008

(54) ENHANCED LOCATION-BASED BILLING FOR GPRS/UMTS NETWORKS

(76) Inventors: Laurent Andriantsiferana, Valbonne (FR); Dhiraj Devdas Ballal, Santa Clara, CA (US); Biswaranjan Panda, Santa Clara, CA (US)

Correspondence Address: SCHWEGMAN, LUNDBERG & WOESSNER, P.A., P.O. BOX 2938, MINNEAPOLIS, MN, 55402, US

(21) Appl. No.: 11/562,871

(22) Filed: Nov. 22, 2006

(51) Int. Cl. H04M 11/00; H04Q 7/20

(52) U.S. Cl. 455/406; 455/456.1

(57) ABSTRACT

A method of processing communication transactions associated with a mobile node communicating with a serving network, the method comprising receiving a first data communication, from an external Location Based Service, the first data communication relating to a first location of the mobile node, processing a communication transaction based on a first charging profile associated with the first data communication, and in response to receiving a second data communication relating to a second location of the mobile node, processing the communication transaction based on a second charging profile associated with the second location of the mobile node.

### FIELD

This application relates to a method and system to facilitate mobile communication, and in an example embodiment to location-based charging for mobile communication within Global System for Mobile Communications (GSM) and Universal Mobile Telecommunications System (UMTS) networks.

### BACKGROUND

In recent years, the use of mobile communications has become widespread, both for voice communication over cellular telephones, as well as for access to the Internet by a variety of mobile and mobile-enabled devices.

Two systems are currently available to facilitate mobile device access to packet-switched networks, such as the Internet and private company networks (e.g., intranets): Global System for Mobile Communications (GSM) and Universal Mobile Telecommunications System (UMTS). A number of services within these two systems are handled by a set of components called the General Packet Radio Services (GPRS) Core Network. These services include mobility management, session management, data transport, and charging (e.g., for billing purposes).

In GPRS networks (for example, UMTS and GSM) it is often desirable to bill users according to the amount of data that they uploaded and/or downloaded as well as the location of the user's mobile node (e.g., the location of the user's cell phone, etc) from which data was uploaded/downloaded.

Within a GPRS core network, the location of a user's mobile node can be determined at different levels: cell, routing area, location area, etc. Only certain components within a GPRS network are aware of the location of a mobile node. The SGSN (Serving GPRS Support Node) is aware of the mobile node's location at the level of a routing area and (in the case of GSM, but not UMTS networks) at the level of a single cell. Thus, billing based on data volume or connection time can be facilitated by an SGSN with billing also based on the mobile node's routing area, location area, and cell.

However, billing that is based on content can only be done by a GGSN (Gateway GPRS Support Node). If the SGSN does not provide location information to its GGSN, the GGSN cannot make use of the location information in its billing processes, in particular in the compilation of Call Detail Records (CDRs). In some areas, the size of a cell may be quite large, relative to the granularity of location information desired for billing purposes. In those areas, even when the SGSN does provide location to the granularity of cell level to its GGSN, this granularity is not sufficiently geographically fine for the purposes of GGSN billing processes.

Location-Based Services are available that maintain detailed and up-to-date databases of precise geographical location of mobile nodes as they move about. This data, however, is not available to the GGSN and thus cannot be used in the GGSN's billing processes.

### BRIEF DESCRIPTION OF DRAWINGS

The present invention is illustrated by way of example and not limitation in the figures of the accompanying drawings, in which like references indicate the same or similar elements and in which:

FIG. 1 shows an example of a mobile communication network for providing packet-based data communication services, according to an example embodiment.

FIG. 2 illustrates a detailed view of part of the communication network illustrated in FIG. 1, according to an example embodiment.

FIG. 3 illustrates a diagrammatic representation of a communication session between a mobile node and a device or service in an external network, according to an example embodiment.

FIG. 4 illustrates components of a gateway device as well as other closely connected components of a communication system, according to an example embodiment.

FIG. 5 illustrates a location-based service as well as several other components within a communication network, according to an example embodiment.

FIG. 6 illustrates a charging profile, according to an example embodiment.

FIG. 7 illustrates a call detail record, according to an example embodiment.

FIG. 8 illustrates an interaction diagram among a serving network, a gateway device, and a location-based service, according to an example embodiment.

FIG. 9 shows a flowchart illustrating an overview of the process for initiating a communication session by a gateway device with a mobile node, according to an example embodiment.

FIG. 10 shows a flowchart illustrating the processing of a call detail record by a gateway node, in some embodiments as it may occur in response to a disconnect request originating from a location-based service upon detecting that a mobile node has moved to a new location, according to an example embodiment.

FIG. 11 shows a flowchart illustrating a process that may be carried out by the location-based service, according to an example embodiment.

FIG. 12 shows an interaction diagram illustrating the process of packet data protocol (PDP) context creation in more detail, according to an example embodiment.

FIG. 13 is a multi-component flowchart that includes three separate regions separated by two vertical dash lines to illustrate processes and communication between a serving GPRS support node (SGSN), a gateway device, such as a gateway GPRS support node (GGSN), and an authentication server connected to a location-based service, illustrating a process for creating a PDP context request according to an example embodiment.

FIG. 14 illustrates a two-component flowchart illustrating the communication between a gateway device, such as a GGSN, and an authentication server connected to location-based service, according to an example embodiment.

FIG. 15 shows a yet further flowchart illustrating in a single diagram the interaction between a gateway device and an authentication server connected to a location-based service, according to an example embodiment.

FIG. 16 shows a diagrammatic representation of machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of an embodiment of the present invention. It will be evident, however, to one skilled in the art that the present invention may be practiced without these specific details.

The following description provides details of example embodiments of mobile communications systems in which a gateway device may be used to provide location-based billing. In the embodiments described in the following descriptions, details of components and methods are presented that allow a gateway device (such as, for example, Gateway GPRS Service Node) to communicate with a location-based service. This communication may allow the gateway device to provide precise and flexible billing based on the characteristics of the communications that gateway device facilitates between a mobile node and devices and systems in an external network (such as the Internet). The billing precision may be further refined based on additionally, and orthogonally, on the geographic location of the mobile node at the time(s) when the communications occurred.

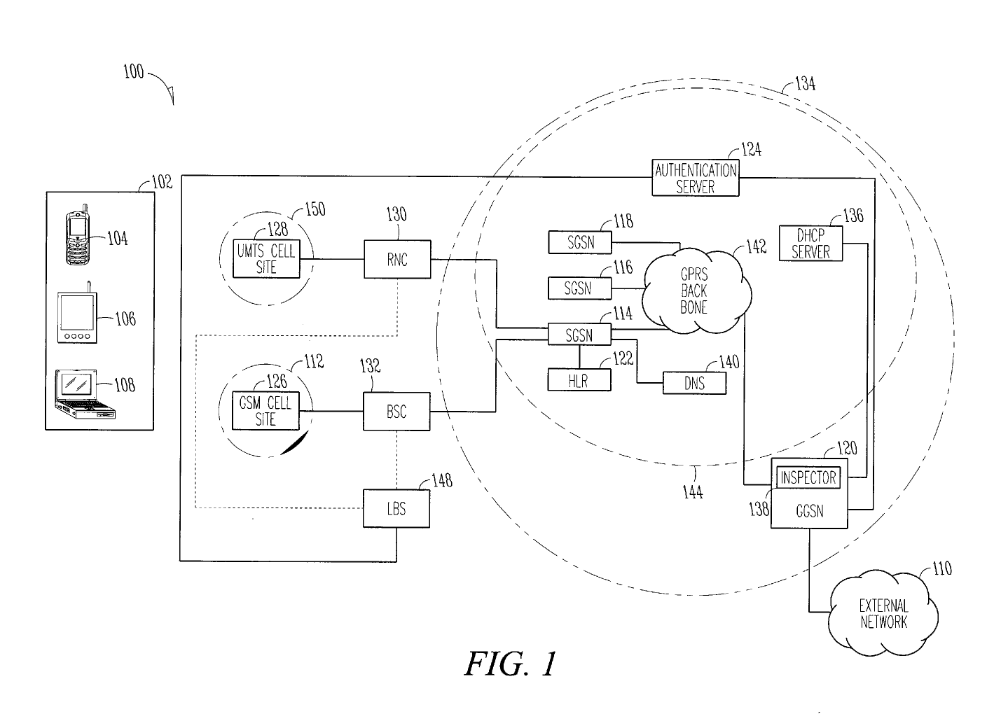

FIG. 1 shows an example embodiment of a mobile communication system 100 for providing packet-based data communication services, in accordance with an example embodiment.

According to an illustrated embodiment of FIG. 1, a system 100 operates to provide services such as communication sessions to endpoints such as mobile nodes 102. Examples of mobile nodes 102 include a cellular telephone 104, a personal digital assistant (PDA) 106, or a portable or laptop computer 108. A communication session may refer to an active communication between endpoints, measured from endpoint to endpoint, in which one or both endpoints may be mobile nodes such as nodes 102. Information is communicated during a communication session. Information may refer to voice, data, text, audio, video, multimedia, control, signalling, other information, or any combination thereof. The system 100 may communicate information in packets. A packet may comprise a bundle of data organized in a specific way for transmission, and a frame may comprise the payload of one or more packets organized in a specific way for transmission. A packet-based communication protocol such as Internet Protocol (IP) may be used to communicate the packets.

The system 100 may utilize communication protocols and technologies to provide the communication sessions. Example communication protocols and technologies include those set by the Institute of Electrical and Electronics Engineers, Inc. (IEEE) 802.xx standards, the International Telecommunications Union (ITU-T) standards, the European Telecommunications Standards Institute (ETS1) standards, the Internet Engineering Task Force (IETF) standards, or other standards.

According to an example embodiment, the system 100 may operate according to the general packet radio service (GPRS) protocols specified by the ETSI Global System for Mobile Communications (GSM) standards. GPRS represents a packet-based data bearer service for communication services that may be delivered as a network overlay for any suitable network configuration. GPRS generally applies packet-radio and packet switching principles to transfer data packets between GSM elements and external packet data networks 110. GPRS may support multiple Internet communication protocols and may enable existing IP, X.25, frame relay, or any other suitable applications to operate over GSM contexts.

The system 100 may include all or a portion of one or more communication networks. A communication network may comprise all or a portion of a public switched telephone network (PSTN), a public or private data network, a local area network (LAN), a metropolitan area network (MAN), a wide area network (WAN), a local, regional, or global communication or computer network such as the Internet or a private (intranet) network, a wireline or wireless network, an enterprise intranet, other suitable communication link, or any combination of the preceding.

In the example embodiment illustrated in FIG. 1, the system 100 is shown to include the mobile node 102, a cell 112, one or more serving GPRS support node (SGSN) 114, 116, and 118, a gateway GPRS support node (GGSN) 120, a home location register (HLR) 122, and authentication server 124, coupled as shown.

The mobile node 102 represents any suitable device operable to communicate with a communication system. In general, a device may include any suitable arrangement of components operable to perform the operations of the device, and may comprise logic such as hardware, software, other logic, or any suitable combination of the preceding. As mentioned above, the mobile node 102 may comprise, for example, a personal digital assistant, a computer such as a laptop, a cellular telephone, a mobile handset, or any other device operable to communicate with the system 100. The mobile node 102 may be uniquely identified by an endpoint identifier. An endpoint identifier may comprise, for example, a mobile station (MS) Integrated Services Digital Network (ISDN) identifier, an International Mobile Subscriber Identity (IMSI), a username, a domain, an access point node, other identifier, or any suitable combination of the preceding.

The cell 112 may represent a geographic unit of a network attachment point of a communication network. As an example, the cell 112 may represent a cell of a cellular network or a hot spot of a wireless network. The cell 112 may have a cell identifier that uniquely identifies the cell 112, and may comprise any suitable identifier. A cell identifier of the cell 112 may comprise an address, for example, a media access control (MAC) address or an IPvx such as IPv4 or IPv6 address, for an access point of the cell 112.

The cell site 126 may represent an access point that provides wireless services to the mobile node 102 present in, or visiting, the cell 112. The mobile node 102 may be present in, or visiting, the cell 112 if the mobile node 102 is within the range of the cell site 126 of the cell 112. An access point may refer to a network point that couples a wireless network, such as a wireless radio network, to a wired network, such as a wired area network.

The cell site 126 may facilitate a handover procedure by redirecting packets, such as traffic or control packets, in response to movement of the mobile node 102. A handover procedure may refer to the process by which a communication session for the mobile node 102 is passed from a previous cell site to a current cell site as the mobile node 102 moves from a previous cell to a current cell. A previous cell refers to the cell in which mobile node 102 is present prior to a handoff, and a current cell refers to the cell in which mobile node 102 is present after the handoff. Cell site 126 may comprise any suitable logic operable to provide wireless services to the mobile nodes 102 present in the cell 112. In an example embodiment, the cell site 126 includes a base transceiver station and a base station controller. The base transceiver station may communicate signals to and from the mobile node 102 through a wireless link that such as a radio frequency link. A base transceiver station may comprise, for example, a 3G Node B. The base station controller manages the operation of the base transceiver station. The cell site 126 may include other or additional logic. For example, the cell site 126 may include a radio network layer (RNL) operable to process packets for each endpoint.

In FIG. 1, two example cell sites are shown: a UMTS cell 150 serviced by a UMTS cell site 128 connected to a Radio Network controller (RNC) 130, and a GSM cell site 126 connected to a Packet Control Unit (PCU) (not shown) and/or a Base Station Controller (BSC) 132. Although the system 100 is shown by way of example to include both UMTS and GSM network components, it should be noted that, in other embodiments, the system may include UMTS components only or, alternatively, GSN components only (but not necessarily both).

The system 100 is also shown to include a GPRS core network 134. The components of the GPRS core network 134 may include various Serving GPRS support nodes (SGSNs) 114, 116, 118, Home location register(s) 122, Authentication server(s) 124, Dynamic Host Configuration Protocol (DHCP) server(s) 136, Inspector(s) 138 (which may be included in the GGSN), a Domain Name Server (DNS) 140, and one or more gateway devices, such as, for example, a Gateway GPRS support node (GGSN) 120. The SGSNs 114, 116, 118 may be connected to their associated GGSN 120 via a GPRS backbone network 142. Components 144 of the GPRS core network 134 connecting the mobile nodes 102 to the gateway device (such as the GGSN 120) and provide an example of a serving network.

The SGSN 114, 116, and 118 and GGSN 120 represent network devices that cooperate in order to facilitate a communication session (such as for communicating data) for or on behalf of the mobile nodes 102. The GGSN 120 may represent a network device that may work in conjunction with multiple SGSNs 114, 116, and 118 to provide a communications medium in a GPRS service network environment, such as, for example a GSM or Universal Mobile Telecommunications System (UMTS) network. At any given moment, a particular SGSN (e.g., the SGSNs 114 or 116) may be servicing communications on behalf of various mobile nodes via various cell sites.

In some example embodiments, any other suitable network device, for example, a router, may perform the operations as described with reference to GGSN 120. The operations of gateway devices, such as, for example, the GGSN 120 are described in more detail below.

The Home location register (HLR) 122 may represent a network device that maintains subscription information for the mobile nodes 102. The subscription information may describe the services to which the mobile nodes 102 subscribe, and may also be used to authenticate the mobile nodes 102.

The Authentication server 124 may represent any suitable device operable to provide authorization-related services. Authorization-related services may include services for authentication, authorization, accounting, or any suitable combination of the preceding. Authentication may refer to validating the identity of the mobile nodes 102. Authorization may refer to giving the mobile nodes 102 permission to perform selected functionality do or to obtain access. Accounting may include tracking the usage of resources. As an example, the Authentication server 124 may provide one, two, or three of the listed services.

The Inspector 138 may represent a network device that inspects packets to identify applications initiated by the mobile node 102. In an example embodiment, the inspector 138 may be a part of the GGSN 120. The Inspector 138 may comprise a wireless application protocol (WAP) gateway, a compression or optimization engine, a billing engine, a service enforcement element, a content authorization or inspection engine, a policy enforcement gateway, or any other element that is operable to inspect, view, modify, process, or transform data or information in a network environment. The Inspector 138 may provide communication session information to GGSN 120.

The Dynamic Host Configuration Protocol (DHCP) server 136 may be used by a gateway device such as GGSN 138 to select a dynamic IP address for each of the mobile nodes 102 on whose behalf the gateway device is to communicate data or other information. The Domain Name Service (DNS) 140 may be used to translate access point names (APN) into GGSN IP addresses to allow mobile nodes 102 to communicate with their assigned GGSN.

The Location-Based Service (LBS) 148 may be used to provide location information to various applications. In an example embodiment, LBS is composed of several elements that interface with SGSN, MSC, HLR and a LBS client to retrieve the location of the mobile node 102. An LBS may triangulate the current position of the mobile nodes 102 (e.g., by monitoring the radio signal strength to the mobile nodes 102 as experienced by the various cell sites, such as cell sites 126 or 128) In an example embodiment, a LBS may monitor Global Positioning System (GPS) signals transmitted by the mobile nodes (e.g., the mobile nodes 102) to determine a current position of each mobile node 102. The LBS 148 may be able to detect the movement of the mobile nodes 102 in terms of service provider defined terms (e.g. movement of a mobile node into or out of a city or service area) and/or to various levels of granularity. In addition, the LBS 148 may be able to report the moment in time when a mobile node moved (or moves) from one region to another and provide a charging profile suited to the newly-entered region for the particular mobile node whose movement was reported. The LBS 148 may be connected, for example, directly to the SGSNs 114, 116, 118, or indirectly to the GGSN 120 (or any other GGSN) via the authentication server 124. Multiple SGSNs, GGSNs, or LBSs may be provided.

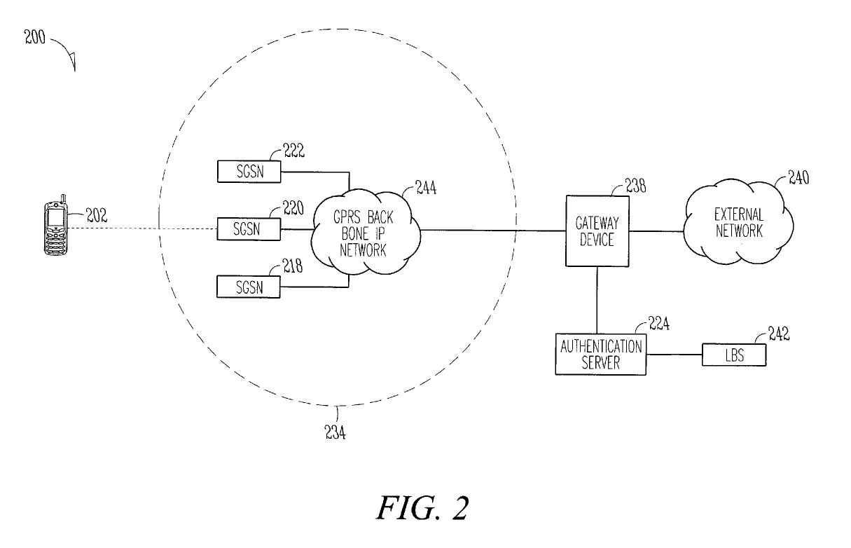

FIG. 2 illustrates a detailed view of part of the communication network illustrated in FIG. 1, according to an example embodiment. In FIG. 2, an example mobile node 202, which may be, for example, a cellular telephone, a portable computer, or a personal digital assistant communicates with a serving GPRS support node (SGSN) 220. This communication may occur through a radio network, as described above. In addition to the SGSN 220, a serving network 234 is also provided and is shown to include a SGSN 218 and a SGSN 222, although the serving network 234 may include any number of SGSN components. In addition, the serving network 234 may include a GPRS backbone IP network 244 that may facilitate communication between the serving GPRS support nodes 218, 220 and 222 with a gateway device 238. The gateway device 238 may also communicate with an external network 240 and may, for example through the external network 240, communicate with a location-based service 242. Location-based service 242 may be connected to the authentication server 224. The authentication server 224 may be connected to the gateway device 238, such as a GGSN.he The gateway device 238 may serve as a gateway or interface between the serving network 234 and the external network 240 in providing or facilitating communication services, such as data transfer, between the mobile node 202 and the external network 240.

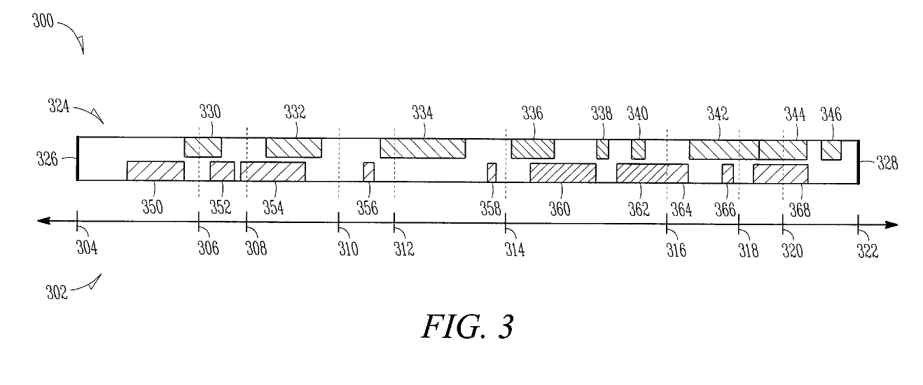

FIG. 3 illustrates a diagrammatic representation of a communication session 300 between a mobile node (e.g., the mobile node 202) and a device or service in an external network (e.g., the external network 240), according to an example embodiment. The communication session 300 may be facilitated by the gateway device 238. FIG. 3 is in the form of a timeline 302 with time increasing towards the right. The elongate glyph labelled 324 represents the communication session itself as facilitated by the gateway device 238 between the mobile node 202 and a device or service in the external network 240. A communication session 324 is bounded by a start time point 326 and an end time point 328. The start time point 326 may represent a beginning of the communication session 324 while the end time point 328 may represent an end of the communication session 324. Within the communication session 324, a number of separate pieces of data transmitted during the communication session are represented symbolically as hatched rectangles. A lower set of hatched rectangles 350, 352, 354, 356, 358, 360, 362 and 364, 366, and 368 represent pieces of data transmitted in the course of the communication session 324 through the gateway device 238 from the mobile node 202 to the external network 240 or to a counterparty, such as a device or service located in, or accessible via, the external network 240. The upper row of hatched rectangles represents data transmitted from the counterparty to the mobile node 202. These are indicated in FIG. 3 with hatched rectangles 330, 332, 334, 336, 338, 340, 342, 344 and 346. For example, the piece of data 356 may be a request originating from the mobile node 202 for a web page, with the data 334 being the requested web page data transmitted from a web server located in the external network 240.

Over the course of the communication session on behalf of the mobile node 202 facilitated by the gateway device 238, the mobile node 202 may move about geographically such as, for example, by being used by a person in a moving vehicle or who is walking around. The service provider of a communication network such as shown in FIG. 2 may divide a service area or region in which it provides service into a number of geographical sub-regions, and each sub-region may have different billing or charging rates. For the purpose of billing or charging for a communication session facilitated by, for example, the gateway device 238, it may be necessary for the service provider to keep track of the time points at which the mobile node 202 moves from one geographical region or sub-region (or any predefined geographical zone) to another. These time points delineating when the mobile node 202 moves from one zone (e.g., geographic sub-region) to another are indicated in FIG. 3 by the time points 306, 308, 310, 312, 314, 316, 318 and 320. Time point 322 indicates the time point of the end of the communication session while time point 304 indicates the time point of the beginning of the communication session 324. These time points as well as the beginning and ending times of the communication session divide the total time of the communication session into a number of time periods. For example, suppose that the mobile node 202 moves from a first geographical sub-region to a second geographical sub-region at time point 314, and at the time point 316 the mobile node 202 moves into a third geographical sub-region. Thus, the mobile node 202 will be entirely within the second geographical sub-region during the time period between time point 314 and time point 316, even though the mobile node 202 may move locally within the second geographical sub-region. In the example communication session 324 illustrated in FIG. 3, during this entire time the mobile node 202 may for example receive from its counter party in the external network 240 three pieces of data 336, 338 and 340. During that same time period, the mobile node 202 may transmit fully the piece of data 360 and partially transmit a second piece of data 362.

In billing a user for the communication of data via the user's associated mobile node 202, through the gateway device 238, the rate charged for the communication of a particular portion of the communication session communicated by a gateway device 238 may depend on various factors. Some factors include: the specific content, the amount of data, the number of web pages from which data in the communication session was received by the mobile node 202, the time of day of communication, the day of the week of communication, etc. The rate charged may depend on the identity of the mobile node or the identity of data for whom the data (either within the data portion, over an entire communication session 324, or even over multiple sessions) was communicated.

All packets communicated during a communication session may be categorized, within the gateway device 238. For each category, volume (uplink and downlink) is reported into charging records along with the location. When the user moves to a new location requiring a new rate, the user session is disconnected, and a new session is created with a new charging profile being applied.

The pieces of data 336, 338, 340, 360 and 362 may be considered portions of the communication session transmitted during the time period bounded by the time points 314 and 316. The data comprising portion are visually notated by the differing hatching in the pieces of data 336, 338, 340, 360, and 362.

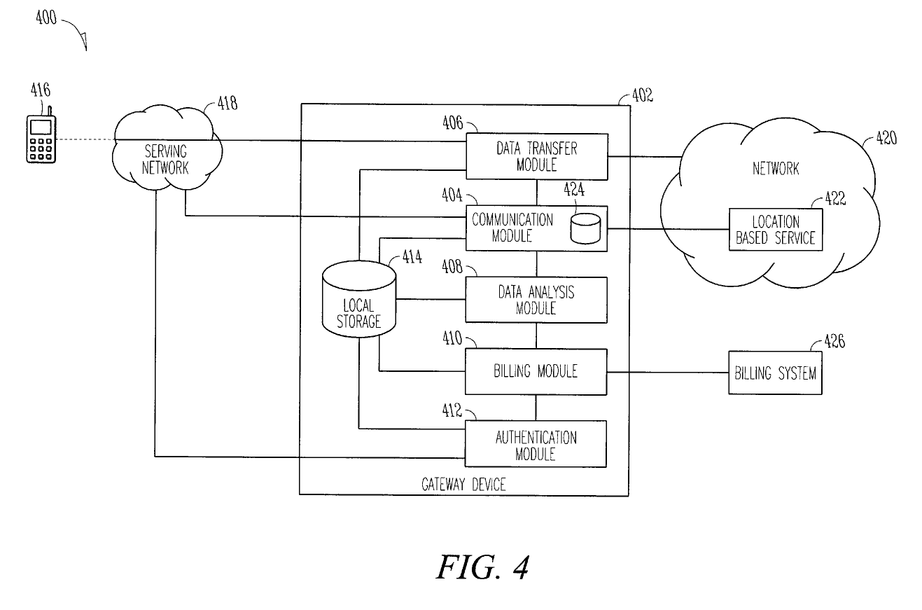

FIG. 4 illustrates components of a gateway device 402 as well as other connected components of a communication system 400, according to an example embodiment. The gateway device 402 may include a number of components including a data transfer module 406, a communication module 404, a data analysis module 408, a billing module 410, an authentication module 412 and local storage 414. The local storage 414, which may take the form of a local disk drive, local memory, or other computer-readable medium, may be used to store data used by one or more of the modules described.

The data transfer module 406 may be used to communicate data through the gateway device 402 on behalf of the mobile node 416. Further, the data transfer module 406 may facilitate the communication of data between a mobile node 416 and other systems such web servers (or other systems/devices) accessed through the external network 420. The communication module 404 may be used for communicating with a location-based service 422 in carrying out processing as described by way of example below. The data analysis module 408 may be used to select charge rates for billing purposes based on the characteristics of data communicated by the gateway device 402 on behalf of the mobile node 416. The billing module 410 may be used to process financial transaction records corresponding to portions of data communicated during a particular time periods. The authentication module 412 may be used for processing packet data protocol (PDP) context creation requests and acceptances, and the local storage 414 may be used by the various modules to store local data in the course of their operations. The billing module 410 may communicate with a billing system 426 which may be used to process billing information and provide billing to user(s) of the mobile node 416. A serving network 418 may facilitate communication between the mobile node 416 and the gateway device 402.

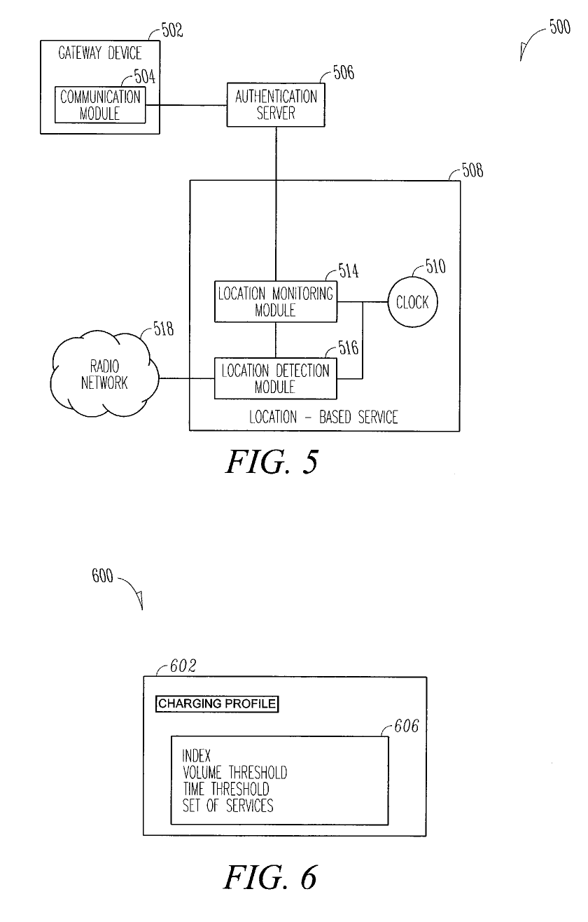

FIG. 5 illustrates a location-based service 508 as well as several other components within a communication network, according to an example embodiment. The location-based service 508 may communicate via an authentication server 506 with a gateway device 502. In an example embodiment, the location-based service 508 includes a location detection module 516 which communicates with a radio network 518 servicing one or more mobile nodes such as the mobile node 416 of FIG. 4. A location monitoring module 514 may communicate with the location detection module 516. The location monitoring module 514 may, in an example embodiment, be configured to detect when a mobile node (e.g., the mobile node 416) moves from one geographical zone (e.g., a sub-region) into another as determined by the location detection module 516. In an example embodiment, the location detection module 516 may continuously monitor the radio network to detect the location of the various mobile nodes. The location monitoring module 514 may use the location data supplied by the location detection module 516 to monitor when particular mobile nodes have moved from one geographical region or sub-region into another. The location monitoring module 514 and the location detection module 516 may, in some embodiments, be connected to a clock 510. This clock 510 may be used by the location-based service to determine a time point at which a mobile node moves from one geographical sub-region to another.

FIG. 6 illustrates a charging profile 602, according to an example embodiment. The charging profile 602 may be stored in a user subscription database and may include a set of charging characteristics. A charging profile identifier may be used by a gateway device 502 to identify a charging profile. A charging profile may include a set of charging characteristics 606. For example, charging profile 602 may correspond to a set of categories or services (e.g., web, wap, ringtones, etc.), and parameters to generate Call Detail Records (CDRs). These parameters may include how often the CDR are generated, what information they contain, a volume threshold, a time threshold, etc.

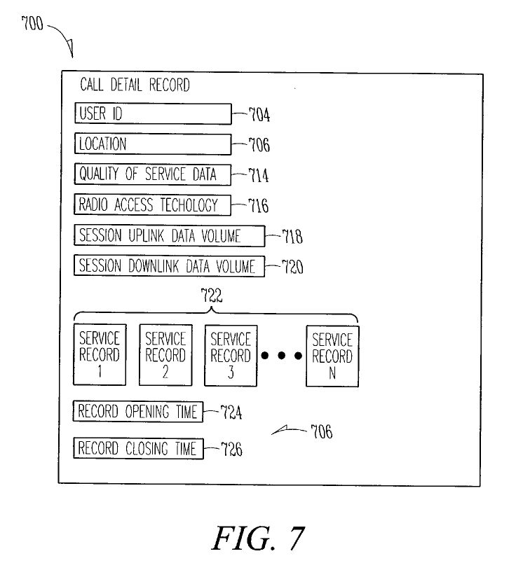

FIG. 7 illustrates a call detail record 702 according to an example embodiment. The call detail record 702, is shown by way of example to include a number of fields or sub-data objects. The call detail record 702 illustrated may include a user or mobile node ID (MSISDN or IMSI) 704 to which the call detail record pertains. It also may include a time period 706, defined by a record opening time 724 and a record closing time 726. The time period 706 may indicate the time period during which the charges described in the call detail record (described below) were accrued. A call detail record 702 may also include a location descriptor 708 that describes a geographical location or geographical sub-region to which the call detail record pertains. The call detail record 702 may include quality of service data 714, radio access technology data 716, session uplink data volume 718, and session downlink data volume 720. Finally, the call detail record may include a list of service records 722.

Each service record 722 may include information about a particular service within the call data record 702. Service records may contain information identifying the particular service (e.g., by a Service ID), as well as location information, quality of service information uplink and downlink data volume, and service record opening and closing times.

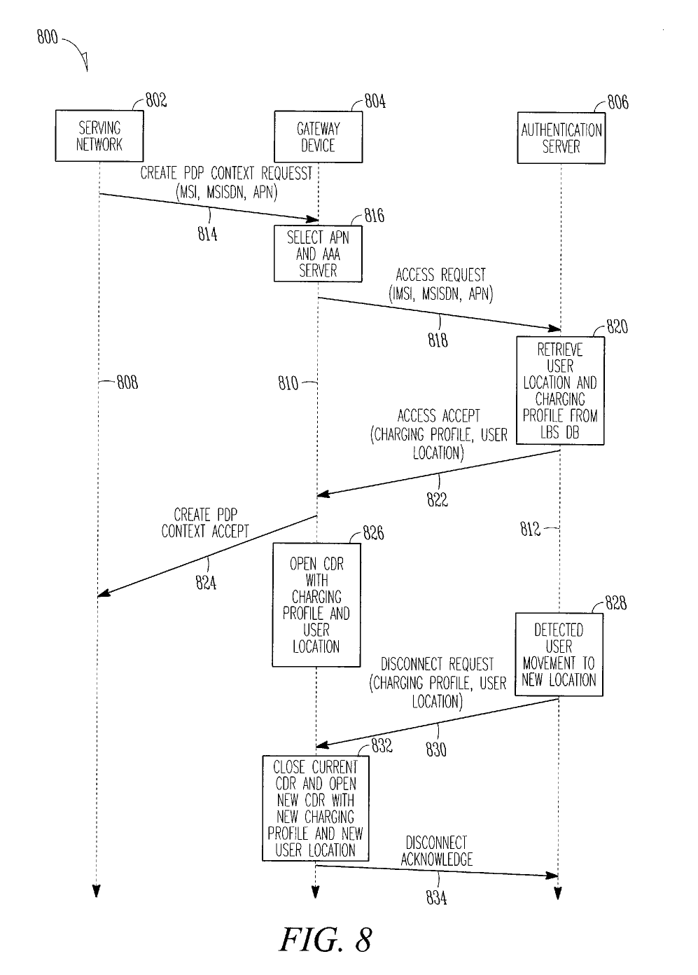

FIG. 8 illustrates an interaction diagram 800 among a serving network 802, a gateway device 804, and an authentication server 806 according to an example embodiment. FIG. 8 further illustrates periods of activation of those three components and example functions carried out during those periods of activation. In the interaction diagram 800 a timeline of the serving network 802 is indicated as 808, the timeline of the gateway device 804 is indicated at 810 and the timeline of the authentication server 806 is indicated as 812. When a user of a mobile node (e.g., the mobile node 416) wishes to initiative a communication session facilitated by the gateway device 402, the mobile node 416 may initiate the process of creating a packet data protocol (PDP) context request within the serving network 802. As part of the process of initiating a communication session facilitated by a gateway device 804 the serving network 802, or in some embodiments a serving GPRS support node (SGSN) may transmit a create PDP context request message 814. The PDP context request message 814 may in some example embodiments contain an identification of the mobile node such as, for example, a Mobile Station Integrated Services Digital Network number (MSISDN) and/or International Mobile Subscriber Identity (IMSI) as well as an access point name (APN). As part of the operation of the gateway device 402, the gateway device 402 may need to select an APN which corresponds to a Service identification for a user (e.g., of a mobile node 416). Further, as part of a gateway device's 402 normal operation the gateway device 402 may interact with an authentication server 224 (e.g., RADIUS server) to authenticate the user and also to provision parameters for this user's session such as IP address, idle timer, charging profile, and so forth.

Upon receiving the create PDP context request message 814 the gateway device 804 may become active at block 816 and select the access point name (APN) for the location-based service or for the authentication, authorization and accounting (AAA) server 806 through which the gateway device 804 may communicate with a location-based service (LBS). The gateway device 804 may then transmit an access request message 818 to the location-based service 806. The access request message 818 may include an international mobile subscriber identity (IMSI) or an MSISDN to identify the mobile node whose location is to be retrieved or monitored as well as an access point name (APN) for the gateway device 804 to facilitate the transmission of data from the location-based service 806 to the gateway device 804 The access point name may correspond to the gateway device 804. In response to the access request message 818, at block 820 the authentication server (AAA) 806 becomes active and may retrieve the user location (e.g., the location of the mobile node 416 identified in the access request from a location-based service (LBS) database), and a charging profile associated with that location (or zone in which the mobile node 416 is located), such as, for example, by retrieving a charging profile from charging profile database. In some example embodiments, in the course of the processing at block 820, a time point may be determined by the location-based service representing the beginning of the communication session. The authentication server 806 may then transmit an access accept message 822 to the gateway device 804. The access accept message 822 may include the user location (e.g., the location of the mobile node 416) at the time point of the beginning of the communication session, as well as a charging profile (e.g., see charging profile 602) associated with the mobile node 416 applicable to that location (or geographical zone). Upon reception by the gateway device 804 of the access accept message 822, the gateway device 804 may finish the process of setting up a communication session for the mobile node 416 and may transmit a create PDP context accept message 824 to the serving network 802. It will be appreciated that the serving network 802, the gateway device 804, and the location-based service 806, may need to have access to, or otherwise connected to or enabled to communicate with, a domain name server (DNS) in order to resolve access point names (APNs) into IP addresses. An example of such a DNS is illustrated in FIG. 1.

At block 826 the gateway device 804, in response to the receipt of the access accept message 822, may open an initial call detail record (CDR) or charging record that includes the charging profile received from the authentication server 806 via the access accept message 822. The CDR may also include the user location and the time point of the beginning of the communication session. Communication between the gateway device 804 and the authentication server 806 my in some example embodiments be done using the Authentication Dial-in User Service (RADIUS) protocol, using the DIAMETER protocol, or any other suitable protocol.

As described by way of example in FIG. 5, the location-based service may monitor (e.g., continuously or intermittently) the location of the mobile node 416 by using the location detection module 516 and the location monitoring module 514 (which may be combined into a single module). Whenever the mobile node 416 moves into a different geographical region or sub-region (or any zone with different charging parameters) within a service area, in an example embodiment a gateway device 804 may close an CDR and open a new CDR to allow the billing module 410 to process financial transaction records based on the charging profile associated with the newly entered geographic region or sub-region. In the course of the communication session, the location-based service may determine that the mobile node has moved into a new zone or new geographic region/sub-region. When the location-based service determines the user's movement into a new zone or geographic region/sub-region with which a new charging profile is associated, the location-based service may transmit the user's new location to an authentication server 806, thus allowing the authentication server to detect the user's movement to the new location. The authentication server 806 in response may transmit a disconnect request message 830 to the gateway device 804. This disconnect request message 830 may include the new charging profile corresponding to the new geographic zone or sub-region into which the mobile node 416 has moved, as well as information describing the new location itself. The disconnect request message 830 may also include the time point at which the mobile node 416 moved out of the previous geographical zone or sub-region and into the new geographical zone or sub-region. This time point may serve to identify the end of the previous time period during which the previous charging profile applied, and to identify the beginning of a new time period in which the new charging profile applies. In response to receipt of the disconnect request message 830, at block 832 the gateway device 804 may close the existing CDR and open a new CDR. The new CDR may include the new charging profile and the new user location as well as the new time point. The gateway device 804, after carrying out the procedure described at block 832, may transmit a disconnecting acknowledge message 834 to acknowledge receipt of the disconnect request message 830 to the location-based service 806. The messages 814, 818, 822, 824, 830 and 834 may be facilitated or carried out by the communication module 404 of the gateway device 402.

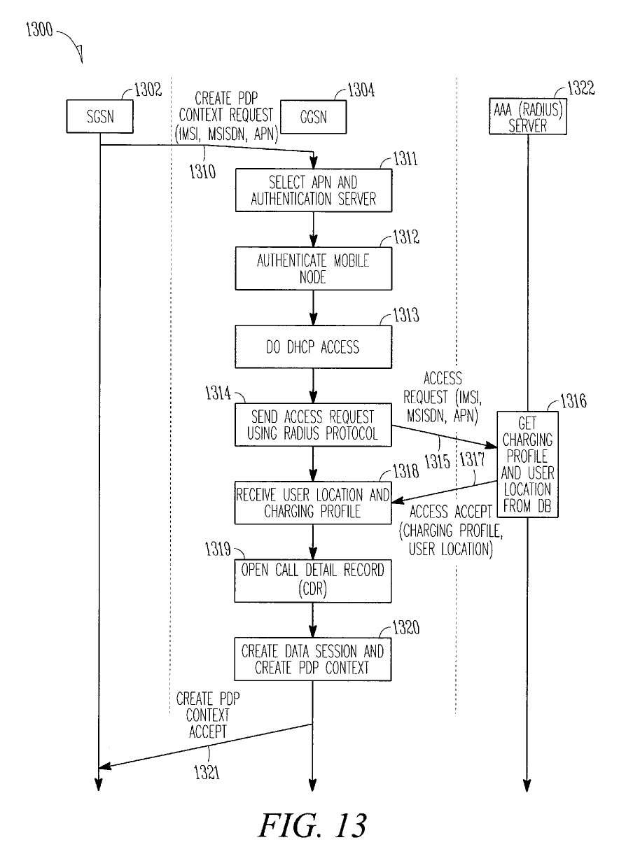

FIG. 8 illustrates by way of example the access accept message 822 and the disconnect request message 830 as including a charging profile which the authentication server 806 may retrieve from a charging profile database. However, in some embodiments the authentication server 806 may not have access to a charging profile database. In those example embodiments the access accept message 822 and the disconnect request message 830 may not include a charging profile. Thus, in those example embodiments the gateway device 402 may need to determine an appropriate charging profile based on the user location or mobile node location transmitted as part of the messages 822 or 830. For example, the gateway device 402 may include a communication module 404 that includes a charging profile database 424 in which a current charging profile for a particular mobile node 416 may be retrieved given location data such as the geographical sub-region of the mobile node 416. In other example embodiments, the communication module 404 may not contain the charging profile database but may have access to the charging profile database through an external network 240 or through the GPRS backbone IP network 244 illustrated in FIG. 2. FIG. 13, described below, provides further example details of a process for communication session setup and PDP context creation request and accept processing.

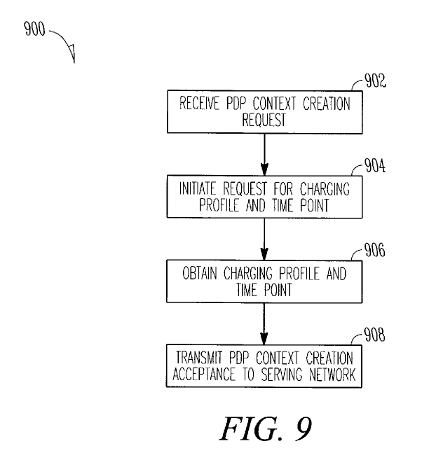

FIG. 9 shows a flowchart illustrating an overview of a method 1000 for initiating a communication session by a gateway device with a mobile node, according to an example embodiment. The method 900 may be deployed in the communication system 400 and, accordingly, is described by way of example with reference thereto.

In the method 900, at block 902 the gateway device 402 (e.g., the communication module 404 may receive a packet data protocol (PDP) context creation request. This PDP context creation request may for example be the create PDP context request 814 shown in FIG. 8. At block 904 the gateway device 402 (e.g., the communication module 404 may initiate a request for the charging profile applicable to the geographic sub-region (or zone) in which the mobile node 416 is located at the beginning of the communication session facilitated by gateway device 402, as well as the time point marking the beginning of the communication session. In response, at block 906 the gateway device 402 may receive the charging profile applicable to the initial geographic sub-region (or zone) in which the mobile node 416 is located when the communication session begins and the time point marking the beginning of the communication session. In an example embodiment the procedure at block 906 also includes obtaining geographic location information describing the initial geographic location such as, for example, the geographic sub-region of the service provider's service region in which the mobile node 416 is initially located, or a latitude and longitude at or near which the mobile node 416 may be initially located.

Finally, at block 908 the gateway device 402 may complete the setting up of the packet date protocol context used to facilitate communication on behalf of the mobile node 416 and may transmit a packet data protocol PDP context creation acceptance back to the serving network 418 so that in some embodiments the serving network may transmit the PDP context information to the mobile node 416 to allow the mobile node 416 to receive and transmit data during the communication session.

This transmission of the PDP context creation acceptance to the serving network 418 is illustrated, for example, by the create PDP context accept message 824 of FIG. 8.

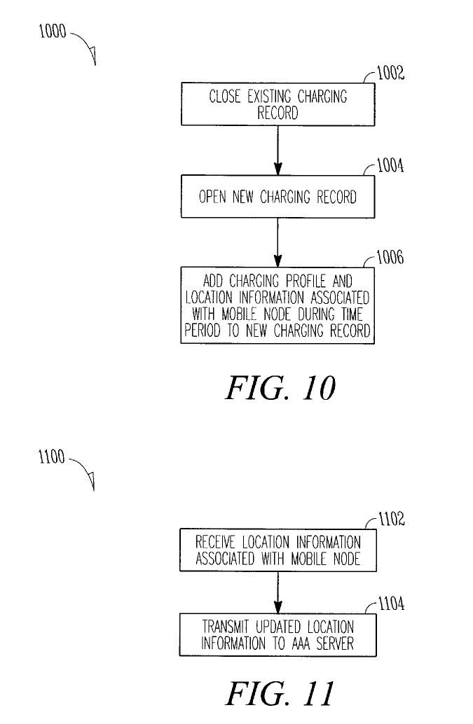

FIG. 10 shows a flowchart illustrating a method 1000 processing a call detail record (CDR) by a gateway device, according to an example embodiment. The method 1000 is described by way of example with reference to the communication system 400 and the interaction diagram 800. In an example embodiment, the method 1000 may be performed by a gateway device 402, as it may occur in response to a disconnect request such as the disconnect request 830 originating from a location-based service upon detecting that the mobile node 416 has moved to a new location (e.g., such as a new geographical sub-region). At block 1002 the gateway device 402 may close an existing charging record such as a call detail record (CDR). This closed charging record may (e.g., also at block 1002) be transmitted to the billing system 426. Upon closing the existing charging record, the gateway device 402 (e.g., the billing module 410) may open a new charging record at block 1004. The opening process may, for example, include creating the new charging record in a memory or other data storage device, such as local storage 414. In an example embodiment this new charging record may be stored in the local storage 414 of the gateway device 402. The method 1000 may be initiated in response to the reception of a message from an authentication server 224 which in turn may be induced by the location-based service 242. That message may include: (1) an indication of the mobile node 416, (2) a time point indicating the beginning of a time period during which the mobile node 416 is located in a new location and (3) the charging profile applicable to the mobile node in that new location, At 1006 the charging profile and location information associated with the mobile node 416 during that time period are added to the newly opened charging record. Once added to the newly opened charging record, this information will be available for further processing such as for analysis of the data communicated on behalf of the mobile node 416 through gateway device 402, as may be done by the data analysis module 408. As indicated at block 1008, the movement of the mobile node 416 to a new location (or zone) may cause the method 1000 to repeat.

FIG. 11 shows a flowchart illustrating a method 1100 that may be carried out by the location-based service 242, according to an example embodiment. The method 1100 may be performed by the location-based service 508 and the communication system 400 and, accordingly, is described by way of example thereto. In the method 1100, at block 1102 the location-based service 242 may determine that a mobile node 202 has moved to a new location. At block 1104 the location-based service may transmit this location information to an authentication server (AAA) 224.

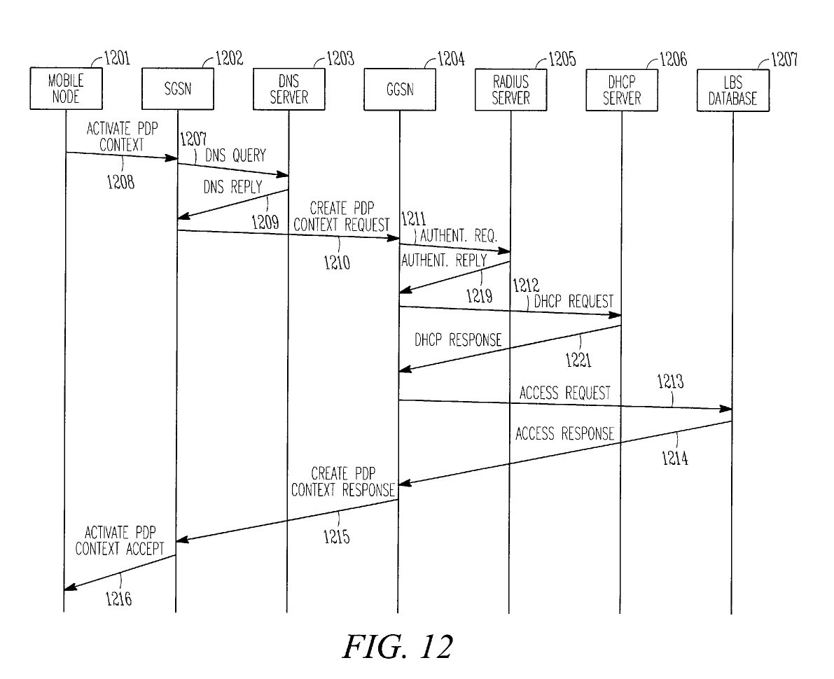

FIG. 12 shows an interaction diagram 1200 illustrating the process of packet data protocol (PDP) context creation in more detail, according to an example embodiment. The participants in the interaction diagram 1200 are shown to be a mobile node 1201, a serving GPRS support node (SGSN) 1202, a domain name server (DNS) 1203 accessible to the SGSN 1202, a gateway device such as a gateway GPRS support node (GGSN) 1204, an authentication, authorization and accounting server such as a radius server at 1205, a dynamic host configuration protocol (DHCP) server 1206 and a location-based service (LBS) 1207. The processing in the interaction diagram 1200 commences with an activate PDP context message 1208 in which the mobile node, in response to a user's desire to connect to an external network such as external network 110 initiates the activate PDP context message 1208. This activate PDP context message 1208 may be received by the SGSN 1202. Using the DNS server 1203, the SGSN 1202 may transmit a DNS query message 1207 and receive a DNS reply message 1209. The DNS query message 1207 may be used to determine the IP address within the GPRS backbone network (e.g., see GPRS backbone network 142) of the GGSN based on an Access Point Name supplied by the mobile node 1201 as part of the activate PDP context message 1208. Thereafter, the SGSN may use the IP address to contact the GGSN and sending a create PDP context request message 1210 to the GGSN 1204. This message may correspond to the create PDP context request message 814 in FIG. 8. In an example embodiment, once this create PDP context request message 1210 is received by the GGSN 1204, the GGSN may transmit an authentication request message 1211 and receive an authentication reply message 1219 from the authentication, authorization, and accounting (AAA) server at radius server 1205. This AAA server may use the RADIUS or DIAMETER protocol. This authentication process allows the gateway device (the GGSN 1204 in the illustrated example embodiment), to determine whether the mobile node 1201 is in fact authorized to obtain communication services on its behalf via the GPRS network.

Once authentication has succeeded, the GGSN 1204 may send a DHCP request 1212 to the DHCP server 1206 which may then provide a DHCP response including a temporary IP address for the mobile node 1201. The GGSN 1204 may then send an access request message 1213 (e.g., via the radius server 1205) to the location-based service and receive (e.g., via the radius server 1205) an access response message 1214. The access response message 1214 may include location information indicating the initial location of the mobile node 1201 and/or a charging profile applicable to the mobile node 1201 at the beginning of its communication session. The GGSN 1204 transmits a create PDP context response message 1215 back to the SGSN 1202 which, in turn, transmits an activate PDP context accept message 1216 to the mobile node 1201. From the PDP context accept message the mobile node may obtain a PDP context with which to initiate transmit and receive communication through the GPRS network to and from an external network (e.g., the external network 110 of FIG. 1). In some example embodiments the three request-response interactions (see messages 121 land 1219, 1212 and 1221, and 1213 and 1214) initiated by GGSN 1204 may be carried out by the communication module 404 of FIG. 4.

FIG. 13 is a multi-component flowchart that includes three separate regions separated by two vertical dash lines to illustrate processes and communication between a serving GPRS support node (SGSN) 1302, a gateway device, such as a gateway GPRS support node (GGSN) 1304 and a authentication server 1322. The flow chart illustrates a method 1300 for creating a PDP context request according to an example embodiment. The method 1300 begins with the transmission by the SGSN 1302 of a create PDP context request 1310. This PDP context request 1310 may include an MSISDN number and/or an IMSI to identify the mobile node 416 for whose benefit the PDP context is being created, as well as an access point name (APN) identifying the service (or set of services) to which the mobile user is subscribed.

At block 1311 the GGSN may select an access point name and also select an authentication server to query as to whether the mobile node for which the PDP context is being requested to be created has permission to use the service provider's GPRS network. At block 1312 the GGSN may use the authentication server selected at block 13 11 to authenticate the mobile node 416. At block 1313 the GGSN may perform a DHCP access to obtain an IP address for the mobile node 416, the mobile node 416 having been authenticated at 1312. At block 1314 the GGSN may send an access request to the location-based service. This access request may be transmitted using the RADIUS protocol or in an example embodiment the DIAMETER protocol. In an example embodiment a RADIUS endpoint may serve as the interface between the GGSN and the location-based service while in other example embodiments the location-based service may be able to receive RADIUS or DIAMETER protocol messages directly from the GGSN 1304. An access request message 1315 (corresponding to the access request message 818 described with respect to FIG. 8) may include an IMSI or MSISDN number to identify the mobile node 416 as well as an access point name. The access request message 1315 may be received by a authentication server 1322. In response, the authentication server 1322 may obtain the charging profile corresponding to the initial location of the mobile node 416 as well as the initial location of the mobile node. The initial location of the mobile node may be obtained from a location based service (e.g. 242). Having obtained this information, the authentication server 1322 may transmit an access accept message 1317 including the charging profile and user location, which may be received at block 1318 by the GGSN. At block 1319, the GGSN, or the billing module 410, may open a call detail record for the communication session for which the PDP context will be used. At block 1320, the GGSN may create the data communication session as well as the PDP context. The GGSN may then transmit a PDP context accept message to the SGSN 1302 which may include information allowing the PDP context to be used by the mobile node 416. In an example embodiment, the functionality in blocks 1311, 1312, 1313, 1314 and 1318 may be carried out by communication module 404 (see FIG. 4).

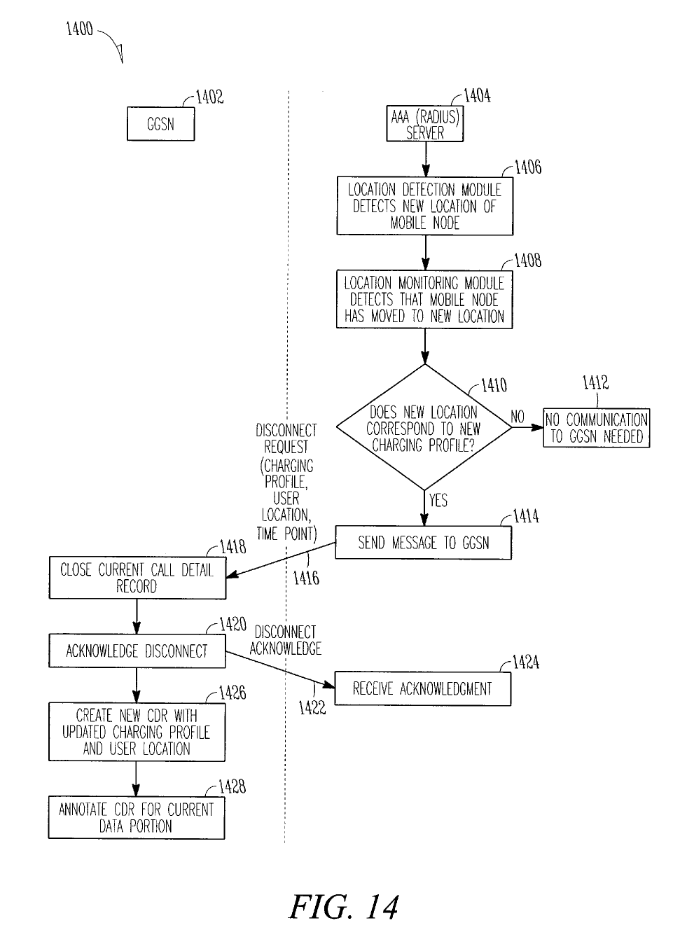

FIG. 14 illustrates a two-component flowchart of a method 1400 illustrating the communication between a gateway device, such as a GGSN, and an authentication server, according to an example embodiment. In the method 1400, an authentication (AAA) server 1404 may, at block 1406, receive a information from a location-based service that the location-based service's location detection module (e.g., location detection module 516 of FIG. 5) detected that a mobile node 416 has moved to a new location. The movement of the mobile node as detected by the location detection module 516 may lead to the location monitoring module 514 to detect the movement of the mobile node 416 to a new location at 1408. At decision box 1410, the authentication server 1404 may determine whether the movement of the mobile node was sufficient to cause the mobile node 416 to enter a new geographical sub-region (or zone) for which a new charging profile is applicable. If the movement of the mobile node 416 is not such as to cause a new charging profile to become applicable to the mobile node 416, then no communication with the GGSN 1402 is needed and location monitoring module 514 may refrain from causing a communication to the GGSN 1402 (see block 1412). On the other hand, if the mobile node 416 has in fact moved into a new geographical sub-region (or zone) for which a new charging profile is applicable, the location monitoring module 514 (or the charging profile serving module 512) may send a message 1416 to the GGSN 1402 as shown at block 1414. This message 1416 and may be termed a disconnect request. The disconnect request message 1416 may include a user location indicating the new geographic sub-region (or zone) into which the mobile node has moved, as well as a time point that may be obtained by the location monitoring module 514 from the clock 510 associated with the location-based service 508. As described by way of example above, this disconnect request 1416 may also include the new charging profile which the authentication server 1404 may obtain from a charging profile database 520 (e.g., operatively connected to a component of the location-based service 508, such as the charging profile serving module 512). Upon receiving the disconnect request message 1416 the GGSN 1402 may close the current call detail record (CDR) at block 1418 and at block 1420 may acknowledge the disconnect request by transmitting a disconnect acknowledgement message 1422 to the authentication server 1404. The transmitting a disconnect acknowledgement message 1422 is shown to be received at 1424.

The processing at the GGSN 1402 continues at block 1426 with the creation of a new CDR that includes the updated charging profile and the new user location. It may also include the time point indicating the time at which the mobile node 416 moved into the new geographic sub-region in which the new charging profile is applicable. It is this time point that may determine the start of the time period for which the charging profile is applicable and data communicated on behalf of the mobile node 416 during this time period should be charged at. At block 1428 the CDR may be annotated in accordance with the portion of data communicated through the GGSN 1402 on behalf of the mobile node 416 during the time period. This annotation may be done at the end of the time period for which the new charging profile is applicable The end of the time period may be marked by the movement of the mobile node into yet another geographic sub-region for which yet another charging profile is applicable, or the termination of the current communication session on behalf of the mobile node.

The functionality illustrated at blocks 1416, 1426 and 1428 may in an example embodiment be carried out by the billing module 410 of a gateway device 402 while the communication module 404 may carry out the disconnect message acknowledgement illustrated at block 1420.

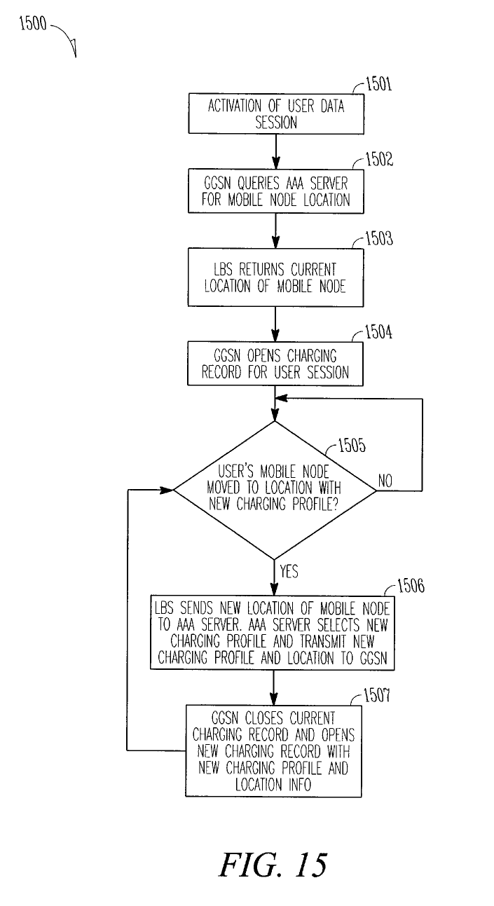

FIG. 15 shows a yet further flowchart of a method 1500 illustrating in a single diagram the interaction between a gateway device and an authentication server connected to a location-based service, according to an example embodiment. The method 1500 may be deployed in the communication system 100 and, accordingly, is described by way of example with reference thereto. At block 1501 the gateway device 238 may activate the user data session to begin a communication session for the mobile node 202. At block 1502 the gateway device 238 (e.g., a gateway GPRS support node or a GSSN) may query an authentication server (being connected to a location-based service) using the RADIUS protocol to determine the initial location of the mobile node 202 and initial applicable charging profile. At block 1503 the location-based service may return the location information describing the initial location of the mobile device 202 and the charging profile applicable to the mobile node 202 in its initial location. At block 1504 the gateway device (e.g., GGSN) 238 may open a charging record for the user data session using the mobile node 202, based on the charging profile selected by the authentication server as appropriate to the initial location of the mobile node 202. At block 1505 the location-based service (e.g., using the location detection module 516) may monitor (e.g., continuously) the mobile node 202 to determine when it has moved to a new location such as a new geographic sub-region that will require a new charging profile. If the mobile node 202 does in fact move to a new location that has a new applicable charging profile, at block 1506 the LBS may send a message to the authentication server 224 with the new location as well as the time point at which the mobile node moved into the new geographical sub-region, whereupon the authentication server 224 may select a new charging profile appropriate to the new location and transmit the new charging profile and location information to the gateway device 238. At block 1507, the gateway device 238 may close the current charging record and open a new charging record with the new charging profile and location information as well as the time point and the identity of the mobile node 202. The functionality performed at block 1505-1607 may be repeated a number of times as the mobile node 202 moves from one geographical sub-region to another (or one zone to another zone) or until the user ends the communication session.

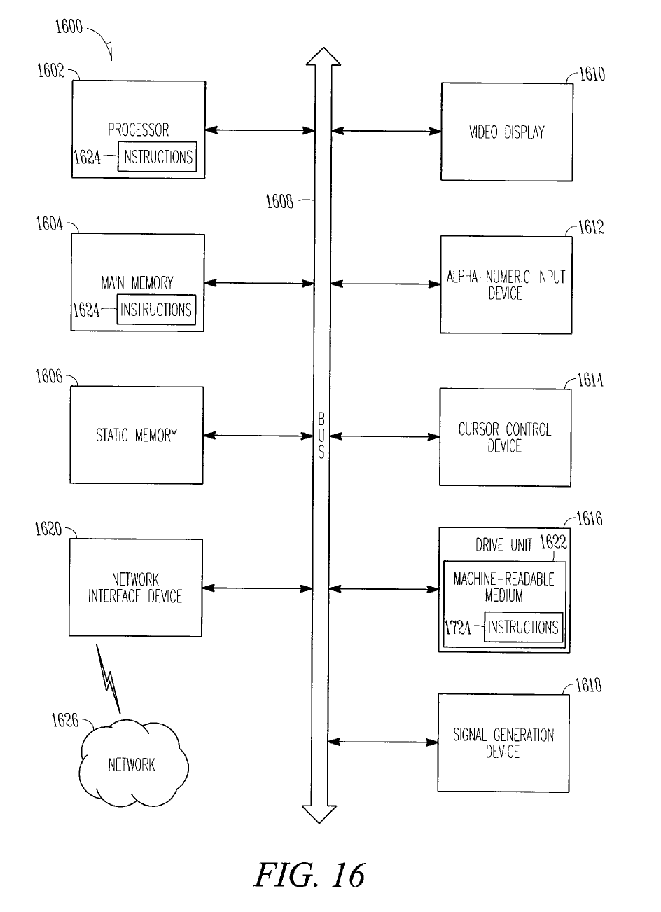

FIG. 16 shows a diagrammatic representation of machine in the example form of a computer system 1600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1600 includes a processor 1602 (e.g., a central processing unit (CPU), a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard), a user interface (UI) navigation device 1614 (e.g., a mouse), a disk drive unit 1616, a signal generation device 1618 (e.g., a speaker) and a network interface device 1620.

The disk drive unit 1616 includes a machine-readable medium 1622 on which is stored one or more sets of instructions and data structures (e.g., software 1624) embodying or utilized by any one or more of the methodologies or functions described herein. The software 1624 may also reside, completely or at least partially, within the main memory 1604 and/or within the processor 1602 during execution thereof by the computer system 1600, the main memory 1604 and the processor 1602 also constituting machine-readable media.

The software 1624 may further be transmitted or received over a network 1626 via the network interface device 1620 utilizing any one of a number of well-known transfer protocols (e.g., HTTP).

While the machine-readable medium 1622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

A machine such as that illustrated in FIG. 16 may be used to implement various components, such as, for example, a mobile node, a serving GPRS support node, a DNS server, a gateway GRPS support node or other gateway device, a DHCP server, an authentication, authorization and accounting protocol server, a billing system, or a location-based service.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method of processing communication transactions associated with a mobile node communicating with a serving network, the method comprising:
receiving a first data communication, from an external Location Based Service, the first data communication relating to a first location of the mobile node;
processing a communication transaction based on a first charging profile associated with the first data communication; and
in response to receiving a second data communication relating to a second location of the mobile node, processing the communication transaction based on a second charging profile associated with the second location of the mobile node.

2. The method of claim 1, which comprises processing the communication transaction at a Gateway GPRS Support Node (GGSN) connected to the serving network.

3. The method of claim 1, which comprises:
identifying the first charging profile from the first location data, the first location being provided by the first data communication; and
identifying the second charging profile from the second location data, the second location being provided by the second data communication.

4. The method of claim 1, which comprises:
receiving the first charging profile from the Location Based Service via the first data communication; and
receiving the second charging profile from the Location Based Service via the second data communication.

5. The method of claim 4, which comprises:
identifying when the mobile node is in a first geographical zone, the first charging profile being associated with the first geographical zone;
monitoring when the mobile node enters a second geographical zone, the second charging profile being associated with the second geographical zone; and
communicating the second charging profile to the serving network when the mobile node enters the second geographical zone.

6. The method of claim 1, which comprises:
receiving the first data communication and the second data communication from the Location Based Service via an authentication, authorization and accounting server.

7. The method of claim 1, which comprises:
receiving the first and second data communications via an authentication, authorization and accounting protocol.

8. The method of claim 1, wherein the first and the second charging profiles comprise type of service-based charging data or content-based charging data.

9. The method of claim 1, wherein the mobile node communicates with the serving network via a data stream, the data stream including a plurality of communication portions, each communication portion being associated with a different charging profile.

10. The method of claim 9, further comprising:
selecting, based on characteristics of the data stream, at least one charge rate identified by a charging profile; and
processing a financial transaction record for each communication portion based on the at least one charge rate and characteristics of the data stream.

11. The method of claim 10, wherein the processing a financial transaction record includes opening a new charging record corresponding to each communication portion of the data stream.

12. The method of claim 10, wherein the characteristics of the data stream include the volume of the data stream.

13. The method of claim 10, wherein the characteristics of the data stream include the content of the data stream.

14. The method of claim 10, wherein the characteristics of the data stream include a count of web pages from which data in the data stream originated.

15. The method of claim 10, wherein the characteristics of the data stream include the time of day that data within the data stream was communicated.

16. The method of claim 10, wherein the characteristics of the data stream include the day of week that the data within the data stream was communicated.

17. The method of claim 10, wherein the characteristics of the data stream include the identity of the mobile node.

18. The method of claim 10, wherein the characteristics of the data stream include the identity of a user for whom data within the data stream was communicated.

19. The method of claim 1, which comprises requesting a data communication from the Location Based Service in response to receiving a packet data protocol (PDP) context creation request message at a GGSN.

20. A network device configured to process communication transactions associated with a mobile node communicating with a serving network, the device comprising:
a communication module configured to receive a first data communication, from an external Location Based Service, the first data communication relating to a first location of the mobile node; and
a transaction processing module configured to process a communication transaction based on a first charging profile associated with the first data communication, and configured to process, in response to receiving a second data communication relating to a second location of the mobile node, the communication transaction based on a second charging profile associated with the second location of the mobile node.

21. The network device of claim 20, in which the transaction processing module comprises a Gateway GPRS Support Node (GGSN) connected to the serving network.

22. The network device of claim 20, which comprises:
a profile identification module configured to identify the first charging profile from the first location data, the first location being provided by the first data communication, and configured to identify the second charging profile from the second location data, the second location being provided by the second data communication.

23. The network device of claim 20, in which the communication module is further configured:
to receive the first charging profile from the Location Based Service via the first data communication; and
to receive the second charging profile from the Location Based Service via the second data communication.

24. The network device of claim 23, in which the Location Based Service comprises:
a location monitoring module configured to identify when the mobile node is in a first geographical zone, the first charging profile being associated with the first geographical zone, and to monitor when the mobile node enters a second geographical zone, the second charging profile being associated with the second geographical zone; and
a charging profile serving module configured to communicate the second charging profile to the network device when the mobile node enters the second geographical zone.

25. The network device of claim 20, in which the communication module is further configured to receive charging profile data together with location data from the Location Based Service in the first and second data communications.

26. The network device of claim 20, in which the communication module is configured to receive the first and second data communications via an authentication, authorization and accounting protocol.

27. The network device of claim 20, wherein the first and the second charging profiles comprise type of service-based charging data or content-based charging data.

28. The network device of claim 20, wherein the mobile node communicates with the serving network via a data stream, the data stream including a plurality of communication portions, each communication portion being associated with a different charging profile.

29. The network device of claim 28, further comprising:
a data analysis module configured to select, based on characteristics of the data stream, at least one charge rate identified by a charging profile; and
a billing module configured to process a financial transaction record for each communication portion based on the at least one charge rate and characteristics of the data stream.

30. The network device claim 29, wherein the billing module being configured to processing a financial transaction record includes being configured to open a new charging record corresponding to each communication portion of the data stream.

31. The network device of claim 29, wherein the characteristics of the data stream include the volume of the data stream.

32. The network device of claim 29, wherein the characteristics of the data stream include the content of the data stream.

33. The network device of claim 29, wherein the characteristics of the data stream include a count of web pages from which data in the data stream originated.

34. The network device of claim 29, wherein the characteristics of the data stream include the time of day that data within the data stream was communicated.

35. The network device of claim 29, wherein the characteristics of the data stream include the day of week that the data within the data stream was communicated.

36. The network device of claim 29, wherein the characteristics of the data stream include the identity of the mobile node.

37. The network device of claim 29, wherein the characteristics of the data stream include the identity of a user for whom data within the data stream was communicated.

38. The network device of claim 20, in which the communication module is further configured to request a data communication form the Location Based Service in response to receiving a packet data protocol (PDP) context creation request message at a GGSN.

39. A system for processing communication transactions associated with a mobile node communicating with a serving network, the system comprising:
means for receiving a first data communication, from an external Location Based Service, the first data communication relating to a first location of the mobile node;
means for processing a communication transaction based on a first charging profile associated with the first data communication; and
means for processing, in response to receiving a second data communication relating to a second location of the mobile node, the communication transaction based on a second charging profile associated with the second location of the mobile node.
